(19) United States
(12) Patent Application Publication
(10) Pub. No.: US 2019/0084169 A1
(43) Pub. Date: Mar. 21, 2019

(54) RAZOR HANDLE

(71) Applicant: LITTLE ACORN SHAVE COMPANY INC., Blaine, MN (US)

(72) Inventors: Allen BONK, Nanoose Bay (CA); Tracy David, Blaine, MN (US)

(21) Appl. No.: 16/132,029

(22) Filed: Sep. 14, 2018

Related U.S. Application Data
(60) Provisional application No. 62/559,181, filed on Sep. 15, 2017.

(51) Int. Cl. B26B 21/52; B26B 21/40

(52) U.S. Cl. CPC B26B 21/522; B26B 21/14; B26B 21/521; B26B 21/4081

(57) ABSTRACT

A razor handle includes an elongated grip portion, a head attachment portion to which a bladed razor cartridge can be attached and an elongated neck portion disposed between the grip portion and the head attachment portion. The grip portion is rigid and the neck portion includes a flexible region. The flexible portion, which is only in the neck portion, flexes to define an optimum shaving pressure on the body surface.

### PRIORITY

This application claims priority to and the benefit of U.S. Provisional Patent Application No. 62/559,181, filed Sep. 15, 2017, which is incorporated fully herein by reference.

### FIELD

The present invention generally relates to razors used for shaving, and more particularly to cartridge-based bladed razors for removing hair from the body, particularly by women.

### BACKGROUND

Razors that women typically use to shave their legs and other body parts is actually optimized for men, not women. These razors feature a short and rigid razor handle that works well for men's beards because of the firm pressure needed for coarse male hair but not so great for the curves, bends, boney and highly sensitive intimate places that women shave. The conventional razors apply too much pressure for a woman's feminine hair, skin and body. The extreme pressure of the rigid razor handle removes layers of skin, thereby causing irritation and razor burn while also causing nicks and cuts around ankles and knees.

Attempts have been made to reduce the irritation problem by adding lubrication/aloe strips around the blades to help minimize the skin irritation. The aloe strips may help soothe the skin after taking the top layers of the skin off in hopes of reducing the burn. However, this does not address the underlying cause of the irritation—that current razors require too much pressure in order to achieve a close shave. Plus, many people find that the aloe strips become slimy, which is unappealing.

There have also been attempts to offer colored razors with contours to provide a more feminine aesthetic, but these attempts do nothing to remedy the underlying functional problem of the short and rigid razor handle. Thus, there remains a need for an improved razor handle that addresses the disadvantages of conventional razors.

### SUMMARY

A razor handle that addresses the disadvantages noted above is disclosed herein.

The disclosure includes a razor handle comprising an elongated grip portion, a head attachment portion to which a bladed razor cartridge can be attached and an elongated neck portion disposed between the grip portion and the head attachment portion. The grip portion is rigid and the neck portion includes a flexible region.

The neck portion can have a narrower width dimension than a width dimension of the grip portion or a width dimension of the head attachment portion. The grip portion can include a flat top surface portion and/or a flat bottom surface portion. The razor handle can be formed unitarily as one single piece. The grip portion can be at least partially coated with a rubber material. The handle can be formed of a polypropylene material.

The head attachment portion, the neck portion and the grip portion together can define a neutral shaving angle of 27 degrees with respect to a skin surface to be shaved. The head attachment portion can be configured to allow for more than 50 degrees of articulation by the razor cartridge when the razor cartridge is attached to the head attachment portion.

The head attachment portion can include a spring member defined along an upper surface of the head attachment portion to keep the razor cartridge in tension when attached to the head attachment portion.

In one non-limiting example, the razor handle is more than 7 inches in longitudinal length and the flexible portion comprises 20% or less of the length of the handle. The flexible region can permit the head attachment portion to deflect by 0.2 inches upon the application of a load of 1.02 pounds to the head attachment portion, to deflect by 0.4 inches upon the application of a load of 1.80 pounds to the head attachment portion and to deflect by 0.6 inches upon the application of a load of 2.95 pounds to the head attachment portion. A longitudinal length of the flexible portion can be 20% or less of an overall longitudinal length of the razor handle. A maximum lateral width dimension of the grip portion can be 10% or less of an overall longitudinal length dimension of the razor handle. A maximum lateral width dimension of the head attachment portion can be 25% or less of an overall longitudinal length dimension of the razor handle.

The disclosure also includes a shaving razor comprising a razor handle as disclosed herein and a bladed razor cartridge secured to the razor handle.

The disclosure further includes a method of shaving hair from a body surface of a human. The method includes gripping by hand a grip portion of a razor handle, while gripping the grip portion, pushing downward towards the body surface, while pushing downward towards the body surface, flexing a flexible segment of a neck portion of the razor handle without flexing the grip portion of the razor handle, to define an optimum shaving pressure on the body surface, and while flexing the flexible segment of the neck portion, sliding a bladed razor cartridge attached to the razor handle across the body surface to sever a hair follicle protruding from the body surface.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a razor handle according to certain embodiments.

FIG. 2 is a side view of a razor handle according to certain embodiments.

FIG. 3 is a top view of a razor handle according to certain embodiments.

FIG. 4 is a bottom view of a razor handle according to certain embodiments.

FIG. 5 is a tail end view of a razor handle according to certain embodiments.

FIG. 6 is a head end view of a razor handle according to certain embodiments.

FIG. 7 is a side view of a razor handle showing a skin contact angle according to certain embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following descriptions, the present invention will be explained with reference to example embodiments thereof. However, these embodiments are not intended to limit the present invention to any specific example, embodiment, environment, applications or particular implementations described in these embodiments. Therefore, description of these embodiments is only for purpose of illustration rather than to limit the present invention.

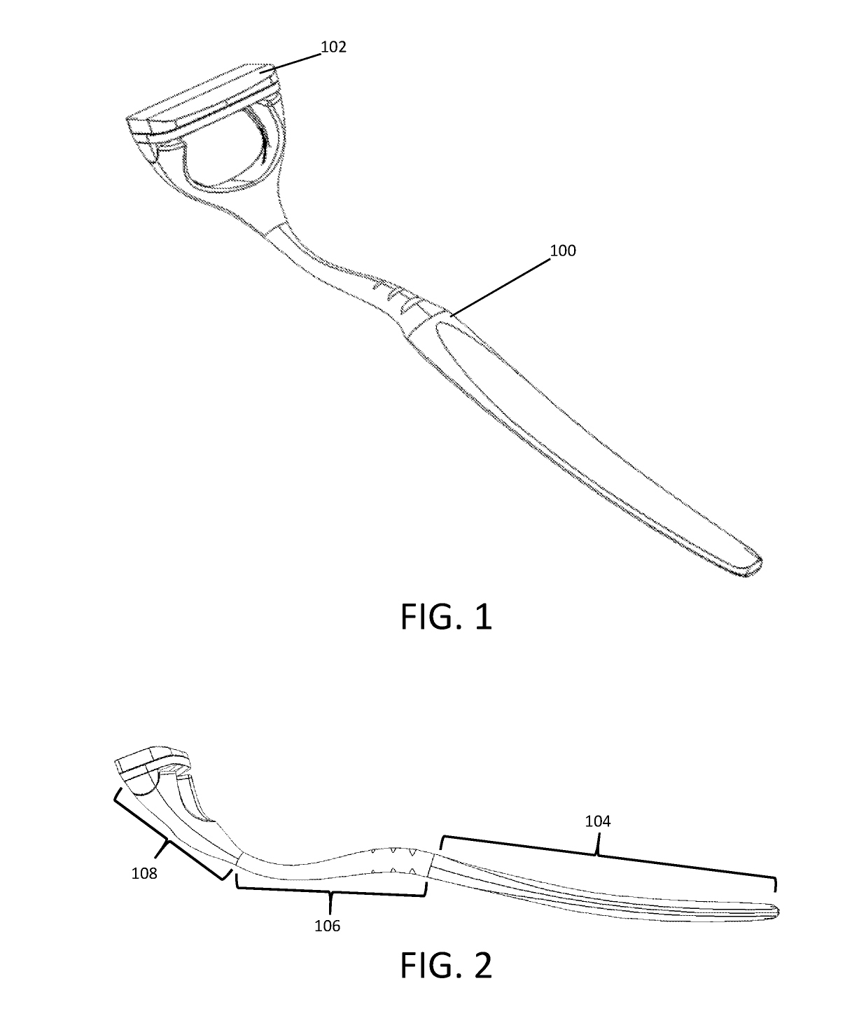

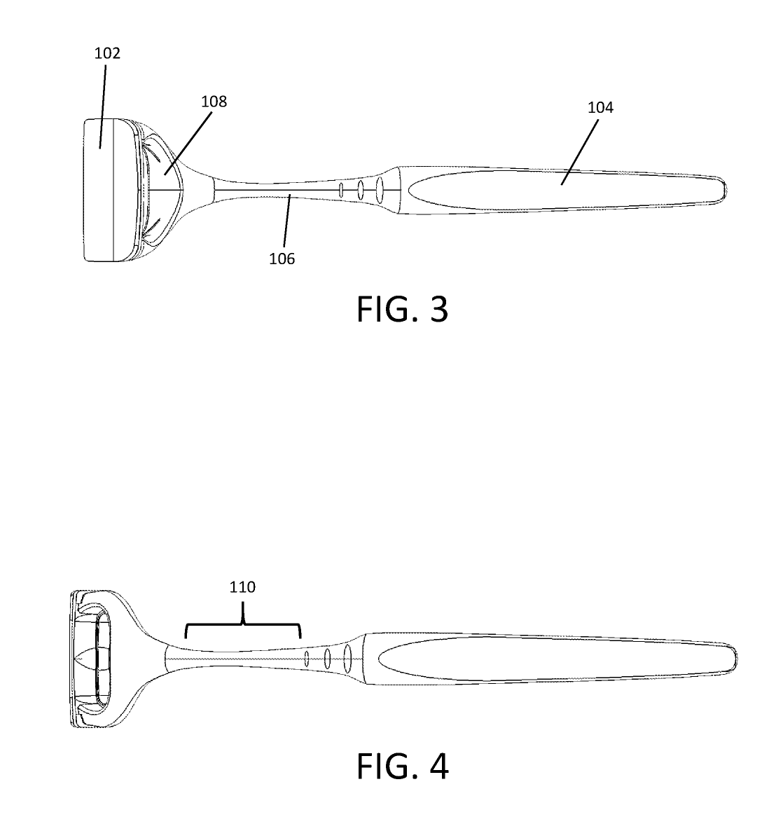

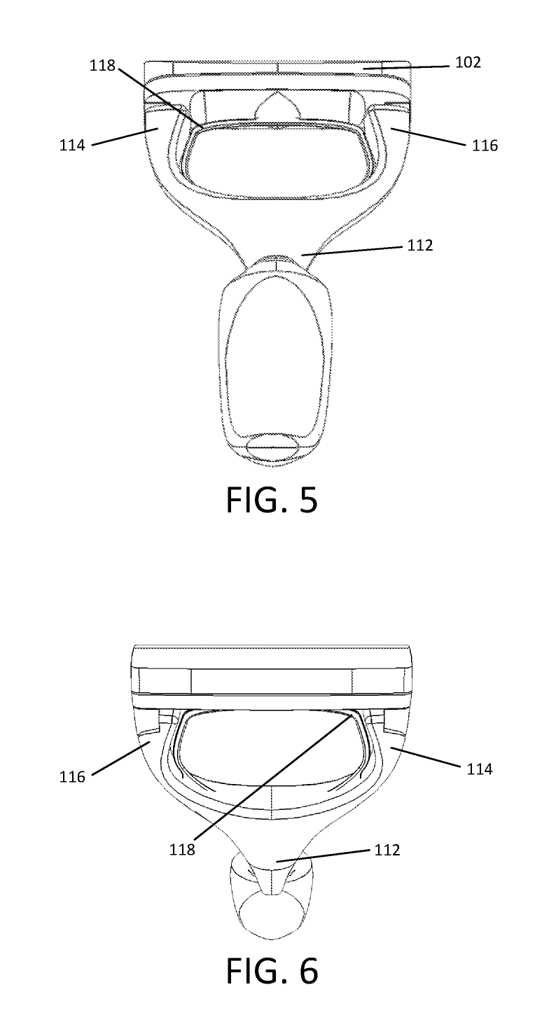

The razor handle 100 according to one example embodiment is shown in FIGS. 1-6. The handle 100 can be fitted with a bladed razor cartridge 102 to form a complete shaving razor. The razor cartridge 102 can be any conventional razor cartridge, including single, double, or other numbers of multi-bladed configurations.

The handle 100 comprises three primary sections or portions: grip portion 104, neck portion 106 and head attachment portion 108. The handle 100 is overall slender in width and relatively long in length. For example, the handle 100 can be approximately 20 cm (7.7 inches) in length. This is about 45% longer in length than conventional razor handles. In certain embodiments, the width dimension of the grip portion 104 is less than 10% of the length of the handle 100 (e.g. 7.7 inches) and the width of the head attachment portion 108 is less than 25% of the length of the handle 100. In one example embodiment with these proportions, the handle length is about 7.7 inches with the head attachment portion being 1.6 inches wide and the grip portion being 0.6 inches wide. Of course, the invention need not be limited to these dimensions or proportions in all embodiments.

The feature of extended length provides several benefits. For example, it is easier for the user to reach the hard to get at places on the body that one might wish to shave. This is particularly true for a woman. Also, the way the handle is intuitively held in the hand due to the additional length automatically invokes a lighter pressure and less down force on the skin. The additional length also imparts a more feminine and luxurious shaving experience for the user, which makes it more likely that the user will not exert undue pressure on the handle during shaving.

The grip portion 104 forms the tail end portion of the handle 100 and is contoured to be gripped by the user's hand. For example, the top and bottom surfaces are larger than the side surfaces spanning between the top and bottom surfaces. The grip portion 104 is also rigid. A partial or full rubber or rubber-like coating can be provided to the exterior surface of the grip portion 104 to reduce the likelihood of slippage in the hand when wet or soapy. Texturing can also be provided to the top and bottom surfaces for enhanced hand grip.

The neck portion 106 is located between the grip portion 104 and the head attachment portion 108. The neck portion 106 is more slender in width than the grip portion 104 and includes a flexible region 110 (indicated in FIG. 4).

The flexible region 110 forms only a small portion (about 4 cm length for a 20 cm handle length—or at most 20% of the handle length) of the overall length of the handle 100 and is positioned only in the neck portion 106. In one example, the flexibility of the flexible region 110 provides for a 0.2 inch deflection of the head attachment portion 108 when a load of 1.02 pounds is applied to the head attachment portion 108. A 0.4 inch deflection results from a load of 1.80 pounds and a 0.6 inch deflection results from a load of 2.95 pounds.

The flexibility of the flexible region 110 creates an optimal predetermined amount of pressure, deflection and recovery for the bladed razor cartridge 102 during use in shaving to aid in following the contours of a woman's body. This force managing flexure makes the razor particularly effective around joints and bones such as the ankle and knee areas. The resulting light and specific pressure also eliminates, or at least greatly reduces, the removal of a layer of skin that conventional razors typically remove. Thus, the undue pressure exerted by conventional razor handles on the blade heads is eliminated and the corresponding nicks, cuts, skin irritation and burning are eliminated.

The head attachment portion 108 forms the head portion of the handle 100 and is configured to secure the bladed razor cartridge 102 to the handle 100. The bladed razor cartridge 102 can be secured by any conventional means and can allow for pivoting movement of the bladed razor cartridge 102 about an axis perpendicular to the longitudinal axis (long axis) of the handle 100. For example, the bladed razor cartridge 102 can pivot plus or minus 27 degrees from a neutral position (thus equating to 54 degrees of pivot travel).

The head attachment portion 108 is rigid and defines a stem portion 112 that is adjacent to the neck portion 106 and laterally-spaced apart first 114 and second 116 legs. The bladed razor cartridge 102 attaches atop the ends of the legs 114, 116.

A spring member 118 is defined along an upper surface of the head attachment portion. This spring member connects to the bladed razor cartridge 102 to keep the cartridge in proper tension.

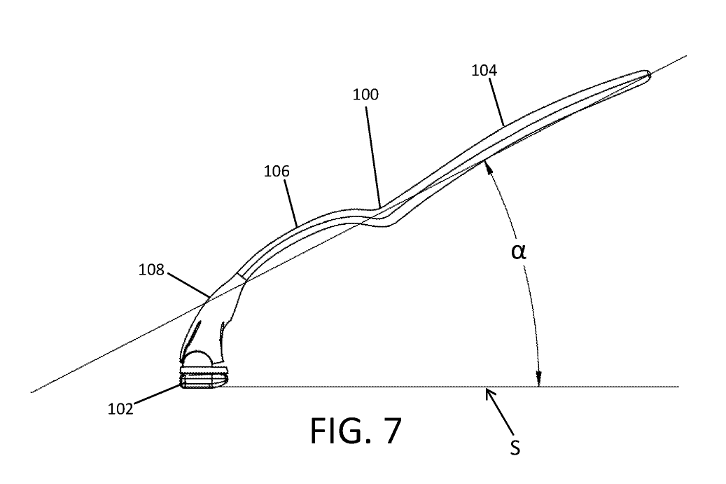

Referring now to FIG. 7, the shave angle, a feature of the razor handle 100 will now be discussed. The handle 100 is configured to be held at an angle α to the shaving surface “S” as depicted in FIG. 7. Angle α is preferably 27 degrees. The angle is achieved by angling one or more of the portions of the handle, such as the head attachment portion 108 and neck portion 104 relative to the hand grip portion 104.

The angle α combines with the extended length and flexibility of the handle 100 relative to conventional razor handles to benefit the razor by presenting the bladed razor cartridge 102 generally perpendicular to the skin of the user when the razor cartridge 102 in its neutral state. This allows the cartridge to have maximum articulation in both directions. Moreover, the angle and raised distance above the skin of the grip portion 104 of the handle 100 aids in the comfortable and stable grasp by the user's hand and does not put the user's wrist at an uncomfortable angle. Thus, the angled configuration handle 100 helps the user to optimally reach the lower portions of their leg, go around the knees and ankles and follow the contour of the leg.

The razor handle disclosed herein can be formed of plastic materials such as polypropylene. Rubber material can be over-molded on part or all of the handle 100 or portions of the handle to help with grip and feel. The handle 100 can be formed of a single unitary piece or multiple pieces can be joined together to form an integrated handle unit.

The razor handle disclosed herein can provide numerous benefits. For example, shave time can be reduced and nicks, cuts and skin irritation reduced or eliminated. This is particularly beneficial for persons who may suffer from skin conditions like psoriasis, eczema and acne because the light pressure exerted on the blades does not irritate those conditions causing flare ups. Ingrown hairs and skins bumps can be reduced or eliminated. Also, the longer handle makes it much easier to reach toes, ankles, back of legs and other difficult to reach areas.

The razor handle discussed herein is particularly suitable for use by women and solves shaving problems encountered primarily by women. However some or all of the aspects of the razor handle can be adapted to a man's razor or to a gender-neutral razor.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A razor handle, comprising:
an elongated grip portion;
a head attachment portion to which a bladed razor cartridge can be attached,
an elongated neck portion disposed between the grip portion and the head attachment portion,
wherein the grip portion is rigid, and
wherein the neck portion includes a flexible region.

2. The razor handle of claim 1, wherein the neck portion has a narrower width dimension than a width dimension of the grip portion or a width dimension of the head attachment portion.

3. The razor handle of claim 1, wherein the grip portion includes a flat top surface portion.

4. The razor handle of claim 3, wherein the grip portion includes a flat bottom surface portion.

5. The razor handle of claim 1, wherein the grip portion includes a flat bottom surface portion.

6. The razor handle of claim 1, wherein the handle is formed unitarily as one single piece.

7. The razor handle of claim 1, wherein the grip portion is at least partially coated with a rubber material.

8. The razor handle of claim 1, wherein the handle is formed of a polypropylene material.

9. The razor handle of claim 1, wherein the head attachment portion, the neck portion and the grip portion together define a neutral shaving angle of 27 degrees with respect to a skin surface to be shaved.

10. The razor handle of claim 1, wherein the head attachment portion is configured to allow for more than 50 degrees of articulation by the razor cartridge when the razor cartridge is attached to the head attachment portion.

11. The razor handle of claim 1, wherein the head attachment portion includes a spring member defined along an upper surface of the head attachment portion to keep the razor cartridge in tension when attached to the head attachment portion.

12. The razor handle of claim 1, wherein the handle is more than 7 inches in longitudinal length and the flexible portion comprises 20% or less of the length of the handle.

13. The razor handle of claim 1, wherein the flexible region permits the head attachment portion to deflect by 0.2 inches upon the application of a load of 1.02 pounds to the head attachment portion.

14. The razor handle of claim 1, wherein the flexible region permits the head attachment portion to deflect by 0.4 inches upon the application of a load of 1.80 pounds to the head attachment portion.

15. The razor handle of claim 1, wherein the flexible region permits the head attachment portion to deflect by 0.6 inches upon the application of a load of 2.95 pounds to the head attachment portion.

16. The razor handle of claim 1, wherein a longitudinal length of the flexible portion is 20% or less of an overall longitudinal length of the razor handle.

17. The razor handle of claim 1, wherein a maximum lateral width dimension of the grip portion is 10% or less of an overall longitudinal length dimension of the razor handle.

18. The razor handle of claim 1, wherein a maximum lateral width dimension of the head attachment portion is 25% or less of an overall longitudinal length dimension of the razor handle.

19. A shaving razor comprising:
a razor handle according to claim 1; and
a bladed razor cartridge secured to the razor handle.

20. A method of shaving hair from a body surface of a human, comprising:
gripping by hand a grip portion of a razor handle;
while gripping the grip portion, pushing downward towards the body surface;
while pushing downward towards the body surface, flexing a flexible segment of a neck portion of the razor handle without flexing the grip portion of the razor handle, to define an optimum shaving pressure on the body surface; and
while flexing the flexible segment of the neck portion, sliding a bladed razor cartridge attached to the razor handle across the body surface to sever a hair follicle protruding from the body surface.
